(19) United States
(12) Patent Application Publication
(10) Pub. No.: US 2023/0351210 A1
(43) Pub. Date: Nov. 2, 2023

(54) MULTIUSER LEARNING SYSTEM FOR DETECTING A DIVERSE SET OF RARE BEHAVIOR

(71) Applicant: FAIR ISAAC CORPORATION, Roseville, MN (US)

(72) Inventors: Joseph Francis Murray, San Diego, CA (US); Firas Kotite, San Clemente, CA (US); Scott Michael Zoldi, San Diego, CA (US)

(21) Appl. No.: 17/732,405

(22) Filed: Apr. 28, 2022

(51) Int. Cl. G06N 5/02

(52) U.S. Cl. CPC G06N 5/022

(57) ABSTRACT

A method, a system, and a computer program product for detecting a diverse set of rare behavior. A time-series data representing one or more actions executed by an entity is received from a plurality of time-series data sources and is processed. A data structure corresponding to the entity, identifying the entity, and including one or more representations of processed time-series data identifying the actions is generated. A current action executed by the entity is detected. Current time-series data corresponding to the current action is received and associated with the data structure. First features are extracted from the generated data structure based on current time-series data and compared to second features extracted for at least another entity to determine difference parameters between first and second features. One or more models are trained using difference parameters, and a score for each action executed by the entity is determined. An action is identified based on the determined scores and the training of the models is updated in response to receiving a feedback data to the identified action, and at least another action is identified. A consistency score is generated for the feedback data.

### BACKGROUND

In many financial and industrial applications, there is a need to detect and respond to rare events as they occur in the time-series behavior of entities. Even with a relatively large team of investigators, only a small fraction of entities can be explored, due to the expense of time and resources for investigation and remediation.

### SUMMARY

In some implementations, the current subject matter relates to a computer-implemented for detecting a diverse set of rare behavior. The method may include processing, using at least one processor, a time-series data received from a plurality of time-series data sources. The time-series data may represent one or more actions executed by an entity in a plurality of entities and stored by at least one time-series data source in the plurality of time-series data sources. The method may further include generating a data structure corresponding to the entity. The generated data structure may identify the entity and include one or more representations of processed time-series data identifying one or more actions executed by the entity. A current action executed by the entity may be detected and one or more current time-series data corresponding to the current action and associated with data structure corresponding to the entity may be received. The method may also include extracting one or more first features from the generated data structure based on one or more current time-series data, comparing one or more extracted first features and one or more second features extracted for at least another entity in the plurality of entities, and determining, based on the comparing, one or more difference parameters being indicative of differences between selected one or more first and second features. The may further include training one or more models, using the one or more difference parameters, and determining, using the one or more trained models, a score for each of the one or more actions executed by the at least one entity, identifying at least one action in the one or more actions based on the determined scores, and updating the training of one or more models in response to receiving a feedback data responsive to the identified at least one action, and identifying at least another action in one or more actions.

In some implementations, the current subject matter can include one or more of the following optional features. At least one of the first features and the second features may include one or more latent features. The training of the models may be performed using the selected first and second features.

In some implementations, the training may include selecting at least one over- and under-representation of a training exemplar or no change to representation.

In some implementations, the feedback data may include feedback data responsive to a utility of the identified at least one action.

In some implementations, the processing may include monitoring the actions executed by the entity, and receiving the time-series data from the plurality of time-series data sources. The actions, behaviors and/or state of the entity may be summarized by one or more representations and may include at least one previously executed action (e.g., historical actions by the entity).

In some implementations, the time-series data may be received during at least one of the following time periods: one or more periodic time intervals, one or more irregular time intervals, and any combination thereof. The time-series data may represents one or more actions executed by the entity during a predetermined period of time.

In some implementations, at least one entity and at least another entity may include at least one of the following: related entities, unrelated entities, and any combination thereof.

In some implementations, one or more difference parameters of the representations may include at least one of the following: latent parameters determined for least comparable entities, parameters determined for most comparable entities, and any combination thereof. This may include a diversity metric for least/most likely entities.

In some implementations, at least another identified action may include at least one of the following: an action identified in addition to the at least one identified action, an action identified for replacing at least one identified action, no action, and any combination thereof (e.g., feedback requests for actions “TriggerRequestMore”, “TriggerRequestLess”, etc.).

In some implementations, the updating may include assigning one or more weight parameters to at least one of: at least one entity and one or more actions executed by the entity, and generating an updated model and an updated score for each of the actions executed by the entity based on the weight parameters. The weight parameters may be determined based on at least the received feedback data. In some implementations, the received feedback data may include one or more labels associated with at least one of: at least one entity and one or more actions executed by the at least one entity. The weight parameters may be determined based on a number of times the feedback data is received for at least one of: the entity and at least another entity being similar to the entity and determined to be within a predetermined distance of the entity. The received feedback data may include feedback data associated with at least another entity being similar to the entity. The received feedback data may include an aggregate feedback data associated with at least one entity and at least another entity being similar to the entity. The feedback data may include a feedback data associated with one or more actions executed by at least one of: at least one entity and at least another entity being similar to the entity. One or more actions may include at least one of the following: at least one identified action, an action identified for replacing the identified action, no action, and any combination thereof.

In some implementations, the method may include generating a consistency score one or more of the investigative users of the system, the consistency score being determined based on receiving a number of times a similar feedback data for at least one of: at least one entity, at least another entity being similar to the entity and determined to be within a predetermined distance of the entity, and one or more actions executed by at least one of: at least one entity and at least another entity being similar to the entity, and any combination thereof, and determining, based on the generated consistency score, whether to use the received feedback data in the updating.

In some implementations, the method may include repeating at least one of the processing, the generating, the detecting, the extracting, the comparing, the training, the identifying, and the updating based on the received feedback data.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for detection of diverse behavior, according to some implementations of the current subject matter;

FIG. 2 illustrates an exemplary density behavior plot for a plurality of entities that may be displayed on a user interface of a user device;

FIG. 3 illustrates an exemplary process that may be performed by the system shown in FIG. 1, according to some implementations of the current subject matter;

FIG. 4 illustrates an exemplary process for determination/measurement of diversity of behavior, according to some implementations of the current subject matter;

FIG. 5 illustrates an exemplary training process, according to some implementations of the current subject matter;

FIG. 6 illustrates an exemplary experimental density behavior plot for a plurality of entities that may be displayed on a user interface of a user device;

FIG. 7 illustrates another exemplary experimental density behavior plot for a plurality of entities that may be displayed on a user interface of a user device;

FIG. 8 illustrates yet another exemplary experimental density behavior plot for a plurality of entities that may be displayed on a user interface of a user device;

FIG. 9 illustrates an exemplary process for providing a feedback, according to some implementations of the current subject matter;

FIG. 10 illustrates an exemplary, experimental table showing how the EntityWeight may be determined for a particular entity;

FIG. 11 illustrates an exemplary, experimental diagram showing impact of multiple user feedback on a customer's EntityWeight, according to some implementations of the current subject matter;

FIG. 12 is a flow diagram illustrating an exemplary process for using EntityWeights to update the OutlierScore queue allocation, according to some implementations of the current subject matter;

FIG. 13 illustrates an exemplary experimental density behavior plot for a plurality of entities that may be displayed on a user interface of a user device;

FIG. 14 is a flow chart illustrating an exemplary process for determining investigator consistency score, according to some implementations of the current subject matter;

FIG. 15 illustrates exemplary, experimental tables showing investigators performance;

FIG. 16 illustrates an example of a system, according to some implementations of the current subject matter; and

FIG. 17 illustrates an example of a method, according to some implementations of the current subject matter.

### DETAILED DESCRIPTION

In some implementations, the current subject matter may be configured to provide an efficient solution that may combine machine-learned models, and automatically incorporate feedback from multiple investigators, in order to find and action on a diverse set of rare, outlier events. The current subject matter may also provide capabilities for supervisors of teams of investigators to obtain feedback on performance to improve quality, consistency, investigator training and bias detection.

Some example applications may include financial crime prevention (e.g., fraud and money laundering) and industrial machine failure detection. In these uses, there is a typically a cost for each entity that is investigated due to being over a threshold score, which has to be balanced with the cost of a missed detection. For example, in the case of money laundering, each case over a threshold requires human investigation, while minimizing the chance of missing criminal behavior. If only the most extreme 0.1% of cases can be investigated, it may be important to ensure that there are no missing important types of criminal behavior (e.g., the algorithm only places unusual international activity in the top 0.1%, missing unusual cash activity). Similarly in the machine failure case, a decision may be made to replace a part for a device with high likelihood of failure, and a threshold on the model will be used to make that decision. It is important to ensure that investigation does not only include a small set of system components (e.g., too many of the alerts indicate failure on one valve or motor).

In some implementations, the current subject matter may be configured to implement an unsupervised anomaly score, and focus investigation on a diverse and wide variety of outlier behaviors. Users of the current subject matter system may provide feedback on which types of new cases are interesting, and the system may adjust automatically to present more relevant entities for investigation. Eventually, a large enough sample of new types of outlier behavior may found, and they may be incorporated into the training set of a supervised machine learning model. The goal of the supervised model may be to very efficiently find entities of interest, lowering false positive rates, for those types of behavior which are well known (and statistically large samples can be collected of each for training). Examples of new types of behavior might include high-velocity online gambling activity (in the AML domain), or a new failure mode of a motor or valve (in the machine failure prediction domain). The current subject matter system may provide a way to explore the topological space of behavior, direct investigation to those parts of the space that are of interest (rare, abnormal behavior), and efficiently find entities with similar behavior.

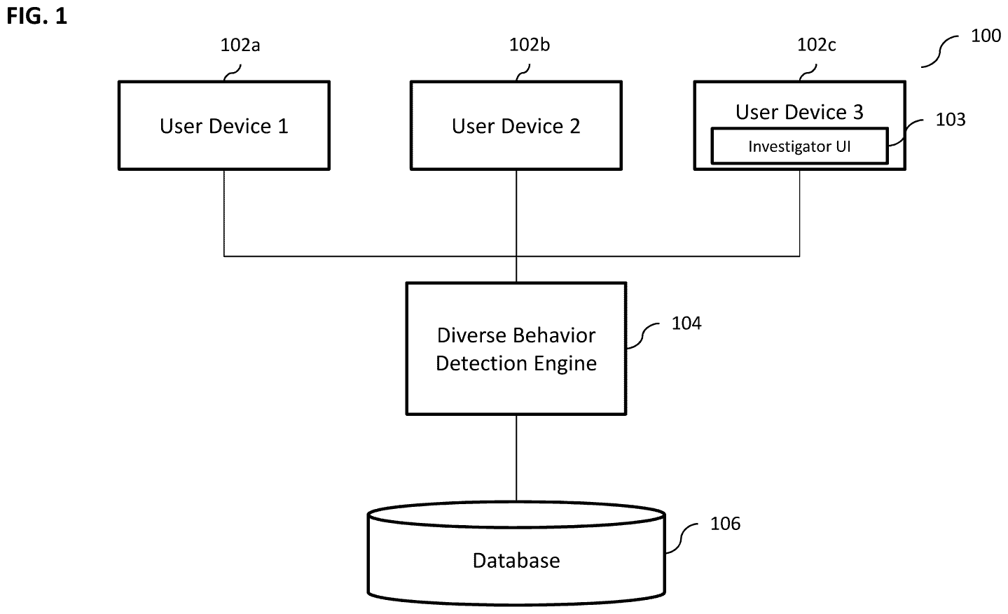

FIG. 1 illustrates an exemplary system 100 for detection of diverse behavior, according to some implementations of the current subject matter. The system 100 may include one or more user devices 102 (a, b, c), a diverse behavior detection engine 104, and one or more databases 106. The system 100 may be configured to be implemented in one or more servers, one or more databases, a cloud storage location, a memory, a file system, a file sharing platform, a streaming system platform and/or device, and/or in any other platform, device, system, etc., and/or any combination thereof. One or more components of the system 100 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The components of the system 100 may include any combination of hardware and/or software. In some implementations, such components may be disposed on one or more computing devices, such as, server(s), database(s), personal computer(s), laptop(s), cellular telephone(s), smartphone(s), tablet computer(s), and/or any other computing devices and/or any combination thereof. In some implementations, these components may be disposed on a single computing device and/or can be part of a single communications network. Alternatively, or in addition to, the components may be separately located from one another.

The engine 104 may be configured to execute one or more functions associated with detection of diverse behavior. Such functions may be executed automatically, e.g., upon detection of a trigger (e.g., receipt of data associated with existing, new, etc. transactions), and/or manually. The devices 102 may refer to user device, entities and/or corresponding to entities, which may be users, applications, functionalities, computers, records, input data records, data structures, and/or any other type of information, data, device, etc. (which may be referred in the following description as “user devices”). In exemplary implementations, some device(s) 102 may be configured to issue queries, receive various results, provide feedback, and/or perform other functionalities associated with the process of detection of diverse behavior. The devices 102 may be equipped with video, audio, file sharing, user interface (e.g., screen) sharing, etc. hardware and/or software capabilities as well as any other computing and/or processing capabilities. The database(s) 106 may be configured to store various data (e.g., time-series data, and/or any other data) that may be accessed for the purposes of determining diverse behaviors.

In some implementations, the engine 104 may be configured to process a time-series data that may be received from a plurality of time-series data sources, such as, for example, database 106 and/or one or more of the user devices 102. The time-series data may represent one or more actions executed by an entity, such as one or more of the user devices 102. The database(s) 106 may be configured to store such time-series data. The time-series data may represent various input records indicative of entity's behavior (e.g., applying for credit, transferring funds, opening credit accounts, etc.).

Each entity may be associated with a particular entity profile or data structure. Such entity profile may be generated by the engine 104 and/or any other computing component. The profile may be configured to identify the entity and include one or more representations (e.g., generated by the engine 104) of the processed time-series data or historical behavior that may identify one or more actions executed by the entity.

The engine 104 may be configured to detect a current action (e.g., opening of a new credit account, commission of a fraudulent action, etc.) that may be executed by the entity. Any time-series data corresponding to such current action may be transmitted to the engine 104 and may be used to make updates to a data structure corresponding to the entity, thereby forming a concise profile of entity behavior. The engine 104 may be configured to analyze the time-series data associated with the current action for the purposes of determining whether the current action does not fit within the pattern of behavior of the entity, e.g., whether the current action corresponds to an outlier action.

In some implementations, the engine 104 may extract one or more features from the generated data structure, i.e., the entity profile, based on one or more current time-series data. Specifically, the features may be extracted from the entity profile and the input data associated with the current action. The extracted features of the entity (e.g., user 1 corresponding to and/or being associated with a user device 102a) may be compared to extracted features of another entity (e.g., user 2 corresponding to and/or associated with a user device 102b). Based on the comparison, difference parameters indicative of the differences between one or more first and second features may be determined. The features may be appropriately selected for the comparison. Using comparison, the engine 104 may determine one or more distances and/or diversities between various entities.

The engine 104 may include one or more machine learning components and may perform training of one or more models using the difference parameters, during which a regularization may be applied to emphasize and/or de-emphasize certain portions, parts, regions, etc. of an input data space based on their diversity. Based on the trained models, a score for each of the actions executed by one or more entities may be determined for the purposes of determining outliers. The scores may help identify questionable actions (e.g., fraudulent, suspicious, etc. actions, activities) by the entities.

In some implementations, the engine 104 may be configured to update training of the models in response to receiving a feedback data (e.g., from one or more investigator-users, e.g., associated with a device 102c, that may correspond to one or more investigators, analysts, etc. (e.g., human users, and/or processors) reviewing actions by entities) received in response to the identified actions. The feedback may be used to identify other actions that may be similar. The user device 102c may include a user-interface 103 that may be used by one or more investigators to make various decisions about identified actions, and provide feedback which may be used to improve the quality of the detection process.

For each entity monitored by the system 100, their behavior may be observed using one or more input records. The system 100 may execute a behavioral profiling process that may receive data associated with each input record and update a behavioral profile of an entity (e.g., in persistent storage and/or database 106) based on a current event (e.g., data received in connection a new transaction executed by an entity (e.g., a purchase, opening of new line of credit, transfer of funds, etc.). The behavioral profile may include a concise, efficient representation of a time-series history of the entity's behavior. It may be efficient as compared to storing and/or retrieving all (or many) of the input records.

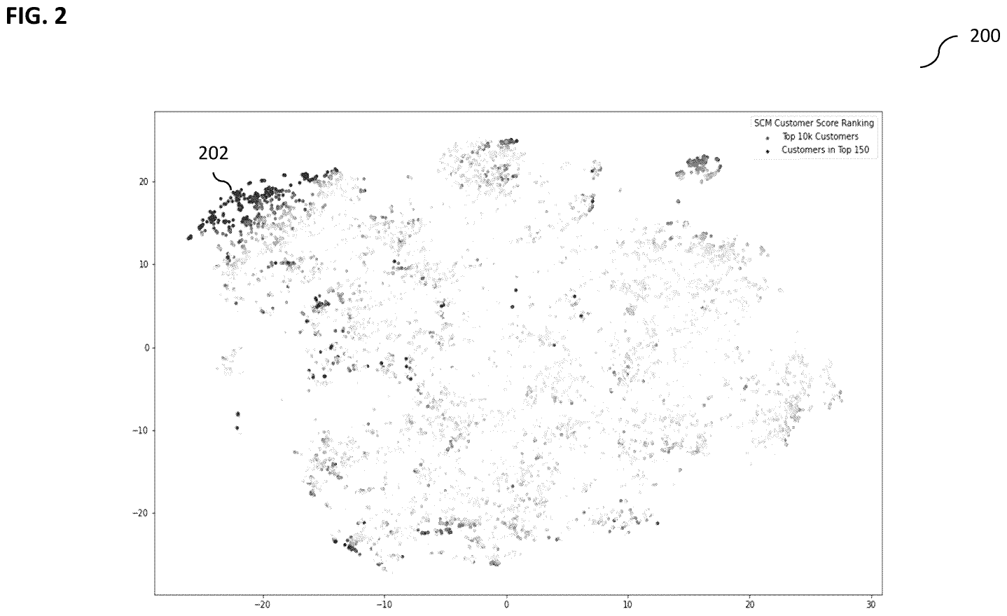

In some implementations, in connection with the entity's profile, a feature vector xi may be constructed as a function of the input record and an entity's profile, so that xᵢ may include information about the current event as well as a historical state. For unsupervised learning, a machine learning model (that may be part of the engine 104) may be configured to estimate a probability p(xᵢ) of that entity's behavior. The engine 104 may be further configured to estimate a density of events that may be associated with an entity behavior. FIG. 2 illustrates an exemplary density behavior plot 200 for a plurality of entities that may be displayed on a user interface of a user device (e.g., investigator's UI 103 of the device 102c). The plot 200 illustrates a distribution of entity behavior in a learned embedding space, showing low-diversity (i.e., high concentration) of rare behavior detected by a baseline system (e.g., system 100 shown in FIG. 1). Points 202 represent the highest-scoring behavior, which is concentrated in the upper left region of the plot 200. Remaining points represent the rest of the high-scoring (and still rare) behavior. Given limited human user time and resources for investigation, it is often desirable to investigate a more diverse set of behavior.

The engine 104 may be configured to use, for instance, a classifier adjusted density estimation (CADE), to determine density. Using CADE, a supervised classifier and base density estimate may be combined to generate an estimate \hat{p}(xᵢ) of a true density p(xᵢ). A base density S may be easily sampled from (e.g., with independence assumptions) to generate \hat{p}(xᵢ|S). A supervised classifier, e.g., a neural network, may be trained to distinguish between data that may be received from an original population T and/or from the base density S. The CADE estimation of the probability of the feature vector may be expressed as follows:

$$\hat{p} ( {x}_{i} \vert T ) = \hat{p} ( {x}_{i} \vert S ) \frac{\hat{p} ( T \vert {x}_{i} )}{\hat{p} ( S \vert {x}_{i} )} \qquad ( 1 )$$

where, \hat{p}(T|xᵢ) is the classifier estimate that xᵢ was drawn from the observed data T, and \hat{p}(S|xᵢ) is the classifier estimate that xᵢ was drawn from the base density S.

The engine 104 may be configured to determine a score to distinguish common behavior of an entity from a rare behavior using the above learned density estimate. In particular, the engine 104 may be configured to determine an OutlierScore—a function of the CADE estimate of the probability (as well as other components of the representation vector), using the following:

OutlierScoreᵢ=ƒ(1−\hat{p}(xᵢ|T), xᵢ ), ∈[0, 999] (2)

The OutlierScore may be calibrated so that low-likelihood behavior is assigned higher scores (maximum of 999) and high-likelihood behavior to lower scores (minimum of 1). By knowing the score distribution on historical data, the engine 104 may select a score-threshold to identify the most important behavior, while limiting a number of entities that need to be reviewed by the investigative user teams. Entities with scores greater than this threshold may be referred to as alerts, and these alerts may be investigated by one or more of the investigator users (e.g., using an investigator UI 103 of user device 102c). Certain risky activity and/or failure modes may be known, and/or codified into rules by expert judgement and/or trained into the supervised learning model. When these rules are triggered, the engine 104 may generate additional alerts, which also may be investigated.

One of the issues with existing approaches to the above problem is that the types of rare events, outliers and anomalies found may not produce a wide enough diversity of entities to examine, and so not cover all the behavior that should be investigated and remediated. The current subject matter system 100, as discussed in further detail below, may be configured to resolve these issues, such as, for example, by providing one or more metrics to determine diversity, and solutions to address, analyze and/or investigate diversity behavior during model training, as well as during on-line operations. Users (e.g., user of device 102c) may interact with the system 100 using user interfaces (e.g., investigator UI 103 of the device 102c) by investigating alerts, some of which may be opened into cases, which may pass through multiple levels of investigation. Cases may eventually be decided to be either normative (e.g., no further action needed), or confirmed as needing action. Further actions may include, for example, but not limited to, reporting the case to a regulatory authority in anti-money laundering, replacing a component in machine failure prevention, etc.

In some implementations, the system 100 may be used in operations where there is already a legacy system which may have generated alerts based on a relatively simple set of rules that monitor entity behavior. Investigator users may have formed decisions about a set of entities (e.g., labelling them as “good” or “bad”). These labels may be used in a semi-supervised learning process discussed below.

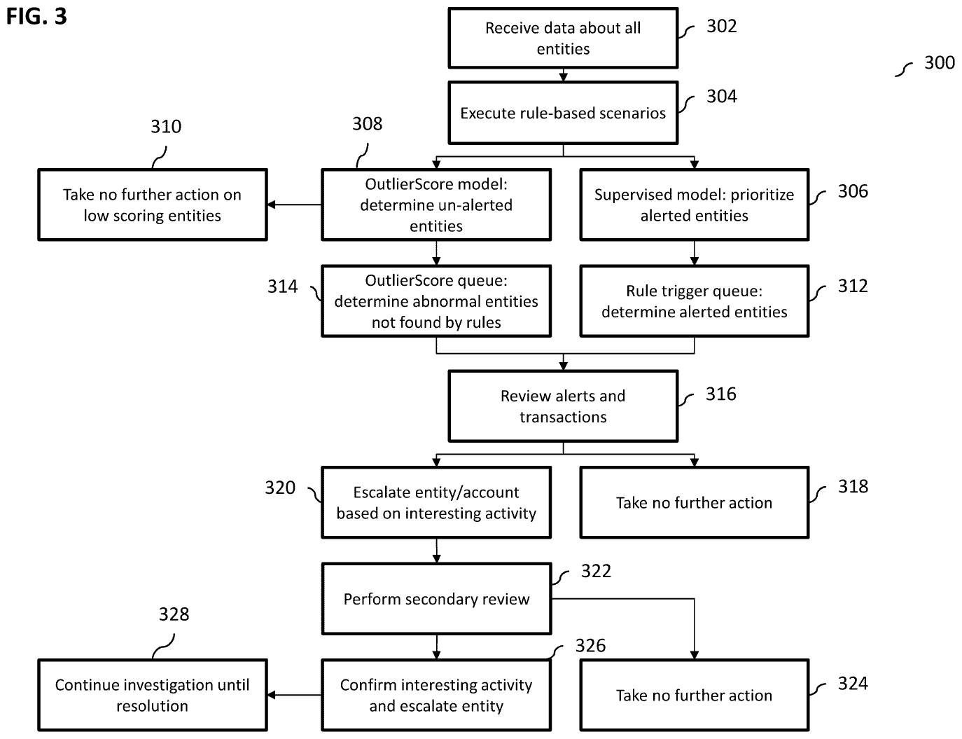

FIG. 3 illustrates an exemplary process 300 that may be performed by the system 100 shown in FIG. 1, according to some implementations of the current subject matter. In particular, the process 300 may executed by the engine 104 to perform an unsupervised anomaly scoring. Using the process 300, alerts may be generated through a set of rules devised from expert human judgement and/or in any other way. Entities that do not trigger a rule and/or do not score above a predetermined threshold may be “closed” without taking any further action, while those that do, may be processed through an extensive investigative process. Referring to FIG. 3, at 302, data (e.g., transaction data, account data, etc.) concerning all entities may be received and one or more rule-based scenarios may be executed by the engine 104, at 304. The processing may then proceed along one or both branches: an OutlierS core model branch and a supervised model branch. In the supervised model branch, any entities that received an alert as a result of execution of the rule-based scenarios (at 304) may be prioritized, at 306, and placed in a rule trigger queue, at 312. In the OutlierScore branch, any un-alerted entities may be determined, at 308. For any low-scoring entities, no action may need to be taken by the engine 104, at 310. Otherwise, abnormal entities that might not have been identified by the executed rules (at 304) may be placed in the OutlierScore queue, at 314.

At 316, the system 100, such as, one or more user devices 102c and/or engine 104, may be configured through a user-interface (e.g., investigator UI 103 of the user device 102c) to review any alerts that have been generated and/or transactions associated with the entities that have been placed into queues (at 312 and 314). If no further actions are warranted on some such alerts/transactions, any further investigation may be closed, at 318. Otherwise, if “interesting” activities are determined, the engine 104 and/or user 102c may escalate the alert/transaction (and/or account associated with the alert/transaction) further, at 320.

As a result, the system 100 may be configured to perform a secondary review of such alerts/transactions that have been identified, at 322. If no further actions are warranted on some such alerts/transactions, any further investigation may be closed, at 324. Otherwise, the system 100 may confirm that these alerts/transactions warrant further review, at 326, and additional investigation of details of such alerts/transactions may be necessary to obtain a resolution, at 328.

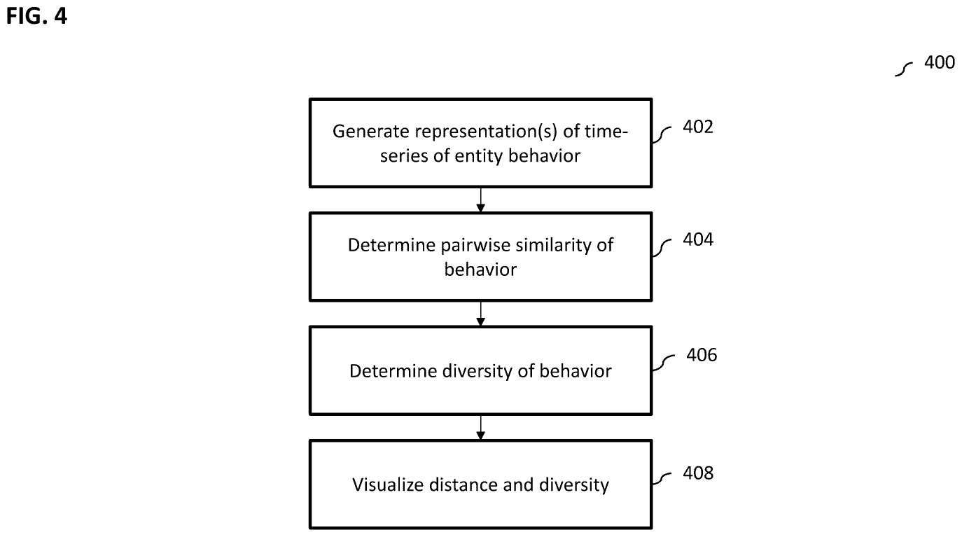

In some implementations, the system 100 may be configured to execute a determination and/or measurement of diversity of behavior of a particular entity as compared with a set of other entities. FIG. 4 illustrates an exemplary process 400 for determination/measurement of diversity of behavior, according to some implementations of the current subject matter. The process 400 may involve representation of time-series of entity behavior (at 402), determination of pairwise similarity of behavior (at 404), determination of diversity of behavior (at 406), and visualization of distance and diversity (at 408).

Referring to FIG. 4, at 402, to represent time-series of entity behavior, each entity may be observed through input data records which may occur at regular or non-uniform sampling intervals. Based on an input record and the behavioral profile record for that entity (e.g., from persistent storage and/or database 106), a representation vector xᵢ of the entities behavior may be generated. The representation vector may include input elements, recursive functions computed through the profile, and/or learned embeddings. The learned embeddings may also be a function of the previous state of entity, e.g., as stored in the profile. The learned embeddings may allow the entities behavior to be modeled as a mixture of behavioral archetypes, and that mixture estimate may be updated with each new input record. The embedding may be learned (e.g., at training time) by first constructing a discrete set of activities that covers the most common behavior of the entities. For example, the discrete set may include a “bag-of-words” (e.g., in analogy with natural language modeling), where, typically, a few hundred “words” may represent most of the range of entity behavior.

The parameters of the embedding may be learned using a neural network and/or using a probabilistic model, such as, for example, latent Dirichlet allocation. The dimensionality of such an embedding may typically be 10-20, which may be a large reduction from the hundreds of “words” possible. At model scoring time, an inference algorithm may be executed to update the embedding for each entity, and may incorporate it into the representation vector xᵢ.

Once the representation of time-series of entity behavior has been determined for each entity, the system 100 may be configured to execute a pairwise similarity of behavior, at 404. The system 100 may be configured to compare a pair of entities. For example, the system 100 may use an Euclidean distance as a metric. However, such metrics may be associated with various difficulties in high-dimensional space. For example, the Euclidean distance between two arbitrary vectors may tend to converge as the dimensionality gets higher. The use of alternative metrics may alleviate this problem, such as, the Lₚ family of metrics, which have shown benefits for p<1 in such spaces. The Lₚ norm as a metric for the distance between two representation vectors xᵢ, xⱼ, may be expressed as follows:

Lₚ(xᵢ, xⱼ)=∥xᵢ−xⱼ∥ₚ=(Σₖ|x_{k,i}−x_{k,j}|^{p})^{1/p} (3)

Based on exemplary, non-limiting, experimental implementations of the current subject matter for a variety of P values, p=2.0 (Euclidean distance), p=1.0, and p=0.1, it was determined that the p=1.0 and p=0.1 provided intuitively better distance measures than p=2.0 (Euclidean) distance, which undesirably often reported high distances between behavior that was quite similar.

Once the distance is determined, the system 100 may be configured to execute a determination of diversity of behavior among entities, at 406. In some implementations, the distance measure provided by equation (3) may be used to determine how similar or diverse the behavior of sets of entities is. For a particular entity xᵢ and a set of related entities H, the diversity may be determined using the following:

$$Diversity ( {x}_{i} , H ) = \frac{1}{\vert H \vert} {Σ}_{j \neq iϵH} {L}_{p} ( {x}_{i} , {x}_{j} ) \qquad ( 4 )$$

If the behaviors of entities in H are very different from each other, the diversity measure will be higher for each entity xᵢ, as compared with other sets of entities with more similar behavior. Entities with high diversity values may be farther away from their neighbors than entities with low diversity. Determining the pairwise distances in the diversity measure may be time-consuming if the set H is large. To avoid the O(n²) computational burden of calculating the metric on all data points, the system 100 may be configured to restrict such determination to a subset of entities, e.g., based on a model score. Further, the diversity metric may be determined on the least likely entities (e.g., based on high scores), and/or the most likely entities (e.g., based on low scores).

A visualization of distance and diversity, at 408, may follow the determination of diversity of behavior. In some implementations, the device 102c of the system 100 may be configured to visualize (e.g., via user interface 103) the requested entity distance from each other using a low-dimensional representation. Such low-dimensional representations may be constructed with the T-distributed stochastic neighbor embedding (t-SNE) to convert similarities in a vector space of data points to probabilities and attempt to minimize the Kullback-Leibler divergence between the joint probabilities of the low-dimensional embedding and the high-dimensional data. T-SNE defines the joint probabilities Pᵢⱼ that measures similarities between Xᵢ and Xⱼ using the following:

$${P}_{j \vert i} = \frac{exp ( - \frac{{d ( {x}_{i} , {x}_{j} )}^{2}}{2 {σ}_{i}^{2}} )}{{\sum }_{k \neq i} exp ( - \frac{{d ( {x}_{i} , {x}_{k} )}^{2}}{2 {σ}_{i}^{2}} )} {P}_{i \vert i} = 0 \qquad ( 5 )$$

$${P}_{ij} = \frac{{P}_{j \vert i} + {P}_{i \vert j}}{2 N} \qquad ( 6 )$$

Calculation of t-SNE may be executing using a standard deviation σ in such a way that the perplexity of Pᵢ equals a user predefined perplexity. Once the 2-dimensional components for each entity are determined, a 2-dimensional (2D) plot may be generated and displayed on a user interface of the device 102c to visualize all (and/or a subset) of the analyzed entities.

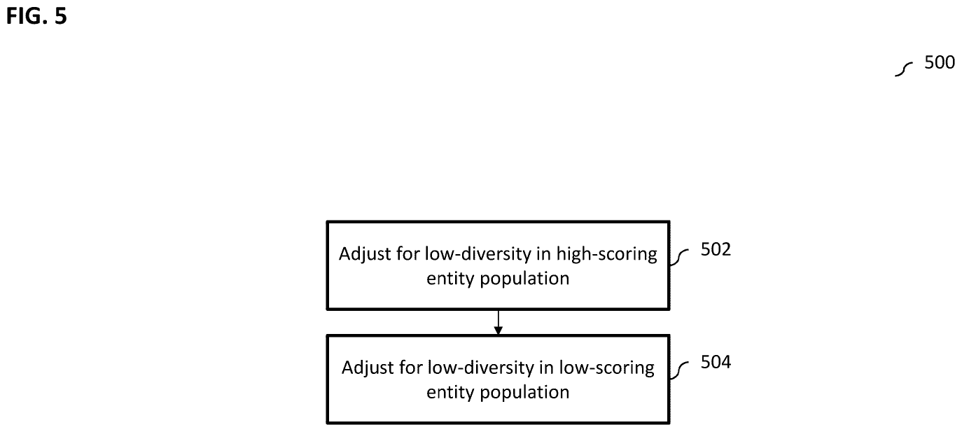

In some implementations, the system 100, and in particular, for example, engine 104 may be configured to execute training to increase system 100's response to diverse behavior. FIG. 5 illustrates an exemplary training process 500, according to some implementations of the current subject matter. Specifically, using the determined metrics for pair-wise distance and group diversity, the engine 104 may be configured to execute processes to adjust one or more scores to increase diversity (e.g., by making alterations to the underlying density estimation process used for unsupervised scoring). The process 500 may include adjustment for low-diversity in high-scoring entity population (at 502), and adjustment for low-diversity in low-scoring entity population (at 504).

To adjust for low diversity in high-scoring population, at 502, the system 100 may be configured to adjust an objective during training time to increase the diversity of the elements that may be found as the highest scoring (e.g., most extreme). This may be interpreted as a regularization of the outlier space to “flatten” and/or normalize the density estimate in the low-probability regions of the domain. In some implementations, the engine 104 may be configured to perform a training-time optimization process to enhance diversity of the outlier population, which may be executed based on finding the distances between elements which are determined to be outliers after some amount of training. The diversity may be a function of the pairwise distances between elements in the set of outliers. Elements with higher diversity factors may on average be further away from most of the other outliers, and may be encouraged to rank relatively higher among the set of outliers.

In particular, as part of the optimization process, after sufficient training of the probability density estimator has occurred (epochs>M), the engine 104 may be configured to determine a set H of highest scoring (least likely) elements and determine one or more pairwise distances between elements xᵢ in set H. Distance may be the Lₚ(xᵢ, xⱼ) metric from equation (3) and expressed as follows: distance(xᵢ, xⱼ)=Lₚ(xᵢ, xⱼ). Then, for each element xᵢ in H, the engine 104 may construct Diversity(xᵢ), which is a function of all the pairwise distances in H, e.g., Diversity(xᵢ){=Σ_{j≠i}distance(xᵢ, xⱼ), and determine the subset H′ of H which has the lowest diversity, H′=xᵢ∈H|Diversity(xᵢ)<−2σ} where σ is the standard deviation of the distribution of Diversity.

Subsequent to the determination of lowest diversity in the optimization process, the engine 104 may be configured to optimize probability density estimator with an additional regularization as function of Diversity. When the CADE approach is used (ŷ is a neural network approximation to the probability that xᵢ is drawn from the true vs base density), the cost function becomes, J=ΣᵢRᵢ*(ŷₗ−yᵢ)², where the regularization factor Rᵢ is,

$${R}_{i} = \{ \begin{matrix}{γ}_{3} * {OutlierScore}_{i} \\ 1\end{matrix} \begin{matrix}if {x}_{i} ∈ {H}^{′} \\ if {x}_{i} ∉ {H}^{′}\end{matrix} ,$$

and γ₁ may be selected so that Rᵢ>1 for those low-diversity entities where reduction of score is desired. The probability density estimation in the optimization process may include an unsupervised learning algorithm. For example, for CADE, elements with higher diversity factor having a lower estimate P(x|T) may be of interest, so those samples may be weighted less in training by using a low γ₁ in the regularization. They may be considered less likely by the model (i.e., higher scoring in applications where higher scores indicate more anomalous samples).

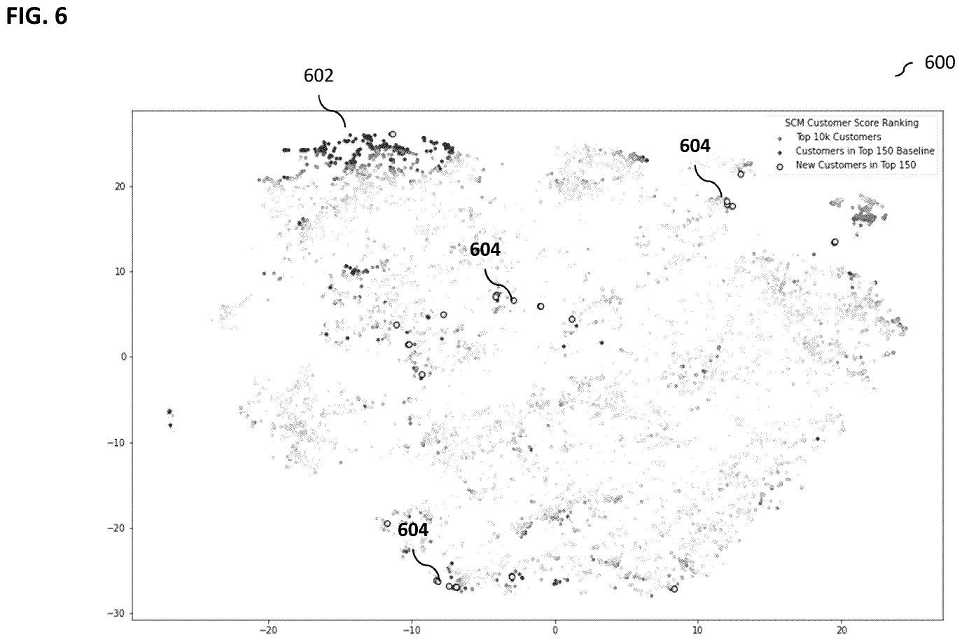

FIG. 6 illustrates an exemplary experimental density behavior plot 600 for a plurality of entities that may be displayed on a user interface of a user device (e.g., e.g., user interface 103 of device 102c). In particular, plot 600 illustrates application of the above optimization process to highest scoring (e.g., most anomalous) entities based on their retail banking behavior. The baseline model, prior to applying the above optimization process, determines that the highest scoring entities are concentrated in region 602 of the space of behavior, demonstrating low diversity of outliers as the top-scoring entities are investigated. By applying the diversity-based regularization of the above optimization process, additional entities 604 with more varied behavior are identified as the top-scoring entities. As a proxy for the utility of the updated score, the number of top-scoring customers who had triggered SAR filings increased from 60/250 (Baseline) to 83/250 (with the above optimization process), or an increase of 38%. While the OutlierScore is intended to find new types of outliers, rather than match existing rules, it may be desirable and expected for some correlation between outliers found purely unsupervised and those found by existing AML rules.

Referring back to FIG. 5, at 504, the engine 104 may be configured to execute adjustment for low-diversity in the low scoring entity population. The optimization process above focuses on adjusting of the highest scoring entities such that they represent a more diverse and more actionable group of behavior. Applying a similar reasoning to the low-scoring population, the system 100 may be configured to reduce an impact of very low scoring entities on the training capacity of the model, which may be relevant when gradient descent (e.g., neural network) based approaches are used for scoring. For that purposes, the system may be configured to execute a regularization process that may be different from the optimization process above. The regularization process may focus on the lowest scoring, low-diversity (versus high-scoring low-diversity in the optimization process) and uses regularization to deemphasize those points in training (versus emphasizing those high-scoring entities to cause their likelihood to increase, and thus score to decrease in the optimization process).

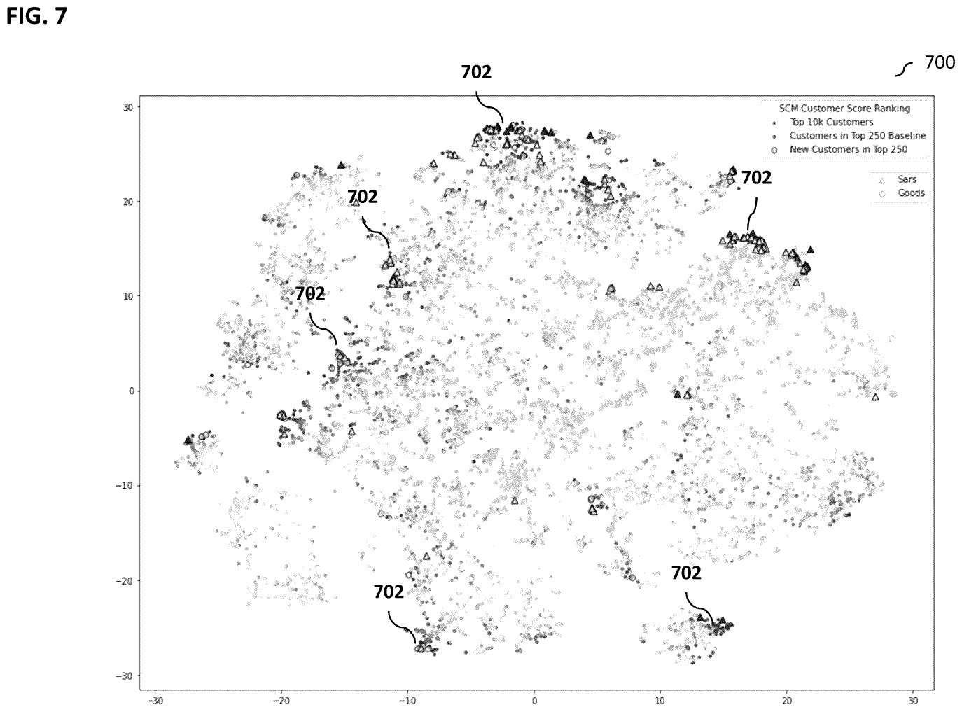

In some exemplary, experimental implementations, application of both optimization and regularization processes to the AML domain, a number of top-scoring customers who had triggered SAR filings increased from 63/250 (Baseline) to 140/250 (with both processes), or an increase of 122%. FIG. 7 illustrates an exemplary experimental density behavior plot 700 for a plurality of entities that may be displayed on a user interface of a user device (e.g., user interface 103 of device 102c). As shown in FIG. 7, there is a large increase in the diversity of the top-scoring entities (702) as a result of the application of both processes.

The regularization process to reduce the impact of low-scoring, low-diversity customers on the estimation of outliers may be initiated after sufficient training of the probability density estimator has occurred (epochs>M). In particular, the engine 104 may determine a set G of lowest scoring (most likely) elements and determine one or more pairwise distances between elements xᵢ in set G. Distance may be the Lₚ(xᵢ, xⱼ) metric from equation (3) and expressed as: distance(xᵢ, xⱼ)=Lₚ(xᵢ, xⱼ). For each element xᵢ in G, the engine 104 may determine Diversity(xᵢ), which is a function of all the pairwise distances in G, e.g., Diversity(xᵢ)=Σ_{j≠i}distance(xᵢ, xⱼ). Then, the engine 104 may determine a subset G′ of G which has the lowest diversity, using G′={xᵢ∈G|Diversity(xᵢ)<−2σ}, where a is the standard deviation of the distribution of Diversity.

The next operation in the regularization process may include optimizing probability density estimator with an additional regularization as function of Diversity. When the CADE approach is used (ŷ is a neural network approximation to the probability that xᵢ is drawn from the true vs base density), the cost function becomes, J=ΣᵢRᵢ*(ŷₗ−yᵢ)², where the regularization factor Rᵢ is,

$${R}_{i} = \{ \begin{matrix}{γ}_{2} & if {x}_{i} ∈ {G}^{′} \\ 1 & if {x}_{i} ∉ {G}^{′}\end{matrix}$$

and γ₂ may be selected so that Rᵢ<<1 for those low-diversity entities where it may be desirable to de-emphasize those to the CADE neural network.

In some implementations, the current subject matter system may be configured to incorporate user feedback in the training process to enhance diversity. In a rare event detection, class labels of some data may be known, due the investigators providing feedback on earlier alerts (either generated by the unsupervised score, or a rules-based system). For data known to be from the rare class, it may be desired to have similar data to be modeled as low likelihood. In this semi-supervised case, the distance metric may be used to find data nearby those rare classes, and regularize training to have similar entities score higher. The labeled samples might not be directly observed during the unsupervised model estimation.

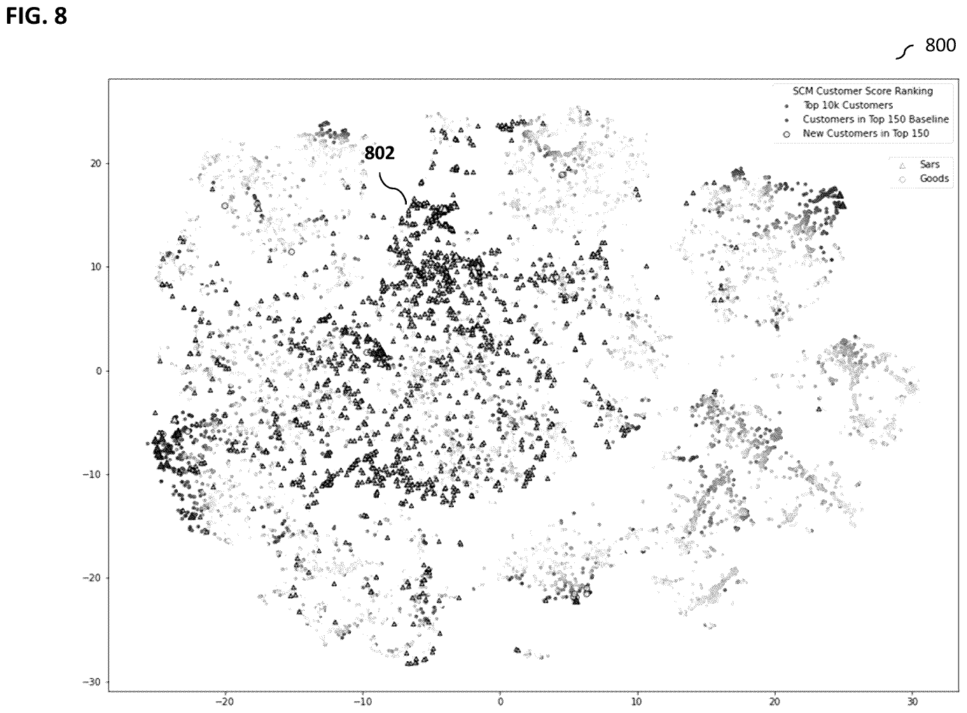

The engine 104 may be configured to execute a semi-supervised approach to using a small amount of labeled data to enhance the diversity of outliers found by the model. Using this approach, previously labelled entities are referred to as “bad” when they have been dispositioned as important (e.g., such as, an entity who had SAR filed in AML, and/or a machine that has been confirmed to fail). FIG. 8 illustrates an exemplary experimental density behavior plot 800 for a plurality of entities that may be displayed on a user interface of a user device (e.g., user interface 103 of device 102c). The plot 800 may be generated after application of the semi-supervised approach and illustrates “bad” entities 802 (shown by darker triangles).

The engine 104 may be configured to execute the semi-supervised approach after sufficient training of the probability density estimator has occurred (epochs>M). In this case, the engine 104 may determine a set H of highest scoring (least likely) entities, determine a set B of previously labeled bad entities, and determine one or more pairwise distances Lₚ(xᵢ, xⱼ) between entities in set H and entities in set B. Then, for each element xᵢ in H and xⱼ in B, the engine 104 may determine a minimum distance to a bad entities as minDistToBad(xᵢ)=min(Distance(xᵢ, xⱼ)), and determine a set H′ which is closest to the bad entities, as H′={xᵢ∈H|minDistToBad(xᵢ)<−σ}, where a is the standard deviation of the distribution of minDistToBad.

Subsequently, the engine 104 may optimize probability density estimator with an additional regularization as function of Diversity. When the CADE approach is used (ŷ is a neural network approximation to the probability that xᵢ is drawn from the true vs base density), the cost function may becomes J=ΣᵢRᵢ*(ŷₗ−yᵢ)², where the regularization factor Rᵢ may be expressed as

$${R}_{i} = \{ \begin{matrix}{γ}_{3} * {OutlierScore}_{i} & if {x}_{i} ∈ {H}^{′} \\ 1 & if {x}_{i} ∉ {H}^{′}\end{matrix} ,$$

and γ₃ may be selected so that Rᵢ<1 for those entities in B where we want to increase their score.

In some implementations, the current subject matter may be configured to incorporate investigator (e.g., user of device 102c shown in FIG. 1) feedback into the online process (e.g., via user interface 103). The feedback may include multiple user feedback and/or immediate individual investigator requests. The system 100 may be used by multiple investigators (e.g., multiple devices 102c), and their feedback (e.g., “more entities similar to current”, “less entities similar to current”) and case dispositioning may be combined to further refine the system's alerts.

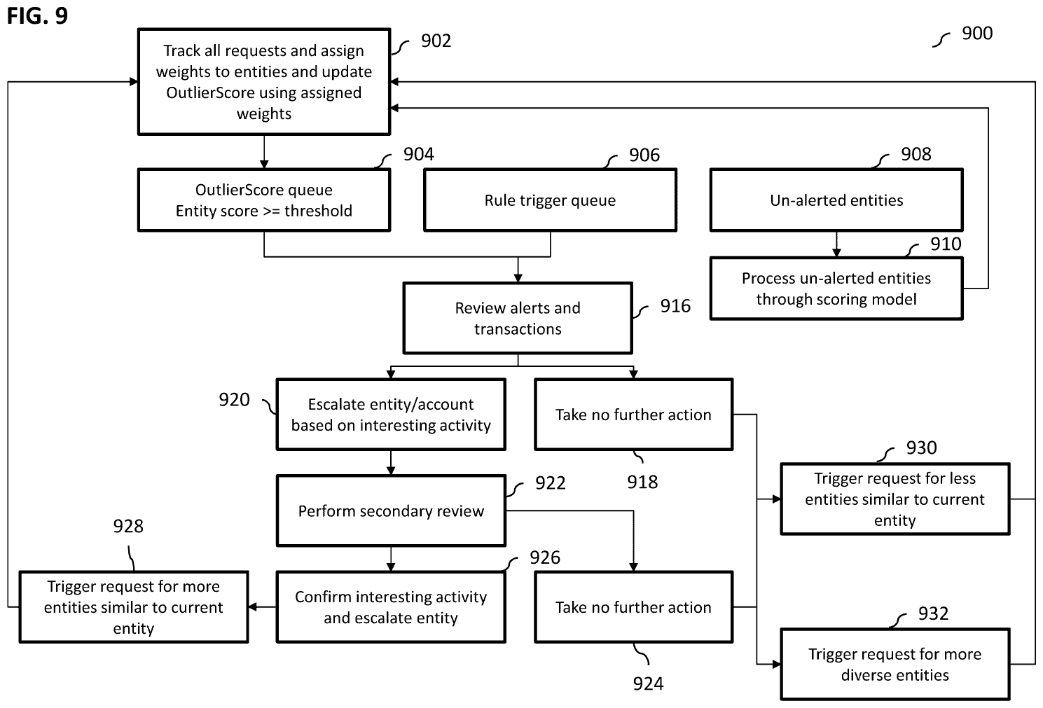

FIG. 9 illustrates an exemplary process 900 for providing a feedback, according to some implementations of the current subject matter. The process 900 may executed by the engine 104. Using the process 900, different type of requests (e.g., more diverse, less diverse, more similar, less similar, etc.) may be provided. Referring to FIG. 9, at 902, data relating to all requests may be tracked by the system 100 and one or more weights may be assigned by the engine 104 to entities. The OutlierScore (as determined above) may also be updated using the assigned weights. At 904, an OutlierScore queue may be populated for entities requests where entity score is greater than or equal to a predetermined threshold. Similarly, at 906, a rule trigger queue may be created. Any un-alerted entities may be identified, at 908, and processed using a scoring model, at 910.

At 916, the system 100, such as, one or more user 102c and/or engine 104, may be configured to review any alerts (e.g., via user interface 103) that have been generated and/or transactions associated with the entities that have been placed into queues (at 904 and 906). If no further actions are warranted on some such alerts/transactions, any further investigation may be closed, at 918. Otherwise, if “interesting” activities are determined, the engine 104 and/or user 102c may escalate the alert/transaction (and/or account associated with the alert/transaction) further, at 920.

As a result, the system 100 may be configured to perform a secondary review of such alerts/transactions that have been identified, at 922. If no further actions are warranted on some such alerts/transactions, any further investigation may be closed, at 924. Otherwise, the system 100 may confirm that these alerts/transactions warrant further review, at 926, and additional investigation of details of such alerts/transactions may be necessary to obtain a resolution. In particular, one or more requests for more entities that similar to the “interesting” entities may be triggered, at 928, and the processing may return to 902.

Moreover, once the system 100 determines that no further action is necessary, at 918 and/or at 924, the system may be configured to trigger further requests. For example, a request for less entities that are similar to the currently evaluated entity may be triggered, at 930. Alternatively, or in addition to, a request for more diverse entities to the currently evaluated entity may be triggered, at 932.

In some implementations, over time, the system 100 may learn from that feedback and provide a set of enriched entities that may be close in distance to what the investigators have found important in the past and may be looking for, which may be expressed as follows:

Distance(xᵢ, xⱼ)=Lₚ(xᵢ, xⱼ)<−2σ (7)

One way the system 100 may accomplish that is by tracking all (and/or a subset) of the requested entities and assigning weights (at 902) based on the number of times a certain entity is close/further from a requested customer. An entity i that appears as a result of multiple users' k requests may be assigned a higher weight (and so prioritized for investigation), and conversely those that appear multiple times in the “less category” may be assigned a lower weight. The weight of each request may decay over time to not bias the requests towards older entities that constantly trigger rules. The following expression may be used to determine an entity weight:

$${EntityWeight}_{i} = {\sum }_{k} \frac{{TriggerRequestMore}_{k}}{{d}_{t , k}} - {\sum }_{k} \frac{{TriggerRequestLess}_{k}}{{d}_{t , k}} \qquad ( 8 )$$

where TriggerRequestMore is the number of times the entity i is requested as being close in Distance(xᵢ, xⱼ) to a customer j of interest under investigation; TriggerRequestLess is the number of times the entity i is requested as being close in Distance(xᵢ, xⱼ) to an uninteresting customer j under investigation; and dt is the number of days since investigator k requested more/less of an entity.

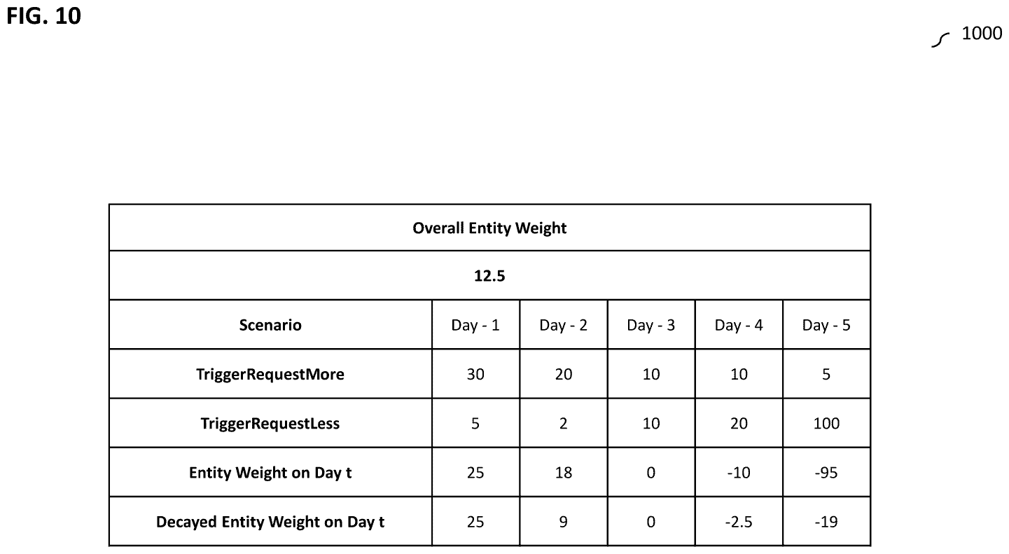

FIG. 10 illustrates an exemplary, experimental table 1000 showing how the EntityWeight may be determined for a particular entity. As shown in table 1000, this entity has in recent days been receiving a higher number of TriggerRequestMore as compared to TriggerRequestLess, which is increasing his EntityWeight. The entity also received TriggerRequestLess in the past which is lowering his overall EntityWeight. Since the TriggerRequestLess occurred further back in time, there impact on the overall Weight is lower than the TriggerRequestMore which gives this entity a positive Weight.

The EntityWeight based on investigator feedback may then be used to scale the unsupervised OutlierScore, using the following:

WeightedOutlierScoreᵢ=OutlierScoreᵢ*(1+α*EntityWeightᵢ) (9)

where α a is a scaling factor to account for operational constraints and workload.

Once determined, an investigator user may customize the amount, frequency, and type of entity they want to prioritize. This may also be performed in conjunction with the score where the weights are used to adjust scores. New entities (e.g., un-alerted entities (at 908-910)), that have a positive weight from requests and that otherwise would not have crossed the required threshold, may be alerted. Entities that scored high (e.g., high-scoring entities), that have a negative weight from requests, may see their score drop below a minimum alert threshold. Entities in the former may then be added to the OutlierScore Queue (at 904) to be worked by an investigator, and entities in the latter may be moved back into a non-alerting node.

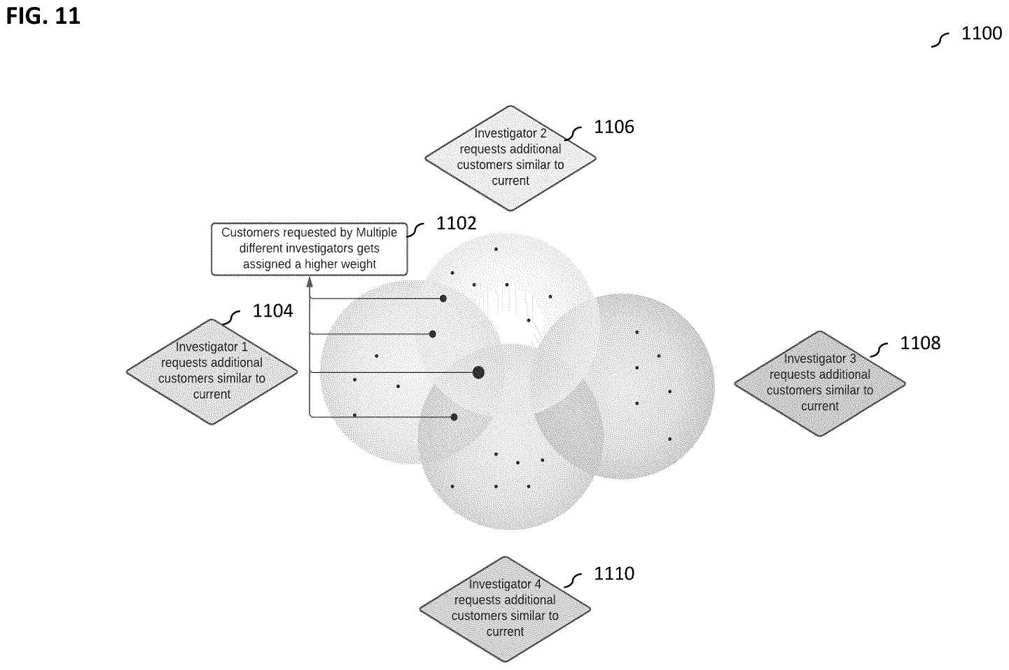

FIG. 11 illustrates an exemplary, experimental diagram 1100 showing impact of multiple user feedback on a customer's EntityWeight, according to some implementations of the current subject matter. The diagram 1100 shows requests by investigators 1104, 1106, 1108, and 1110 (e.g., via investigator UI 103, as shown in FIG. 1) all requesting (requests additional entities (“customers”) similar to currently investigated entity. As more investigators trigger requests for more entities similar to those currently investigator, their EntityWeight increases. Thus, the entity 1102 is nearby in behavior space (as found by Investigator 1104, 1106, and 1110's requests) and as such, has a higher weight than customers requested only by a single investigator.

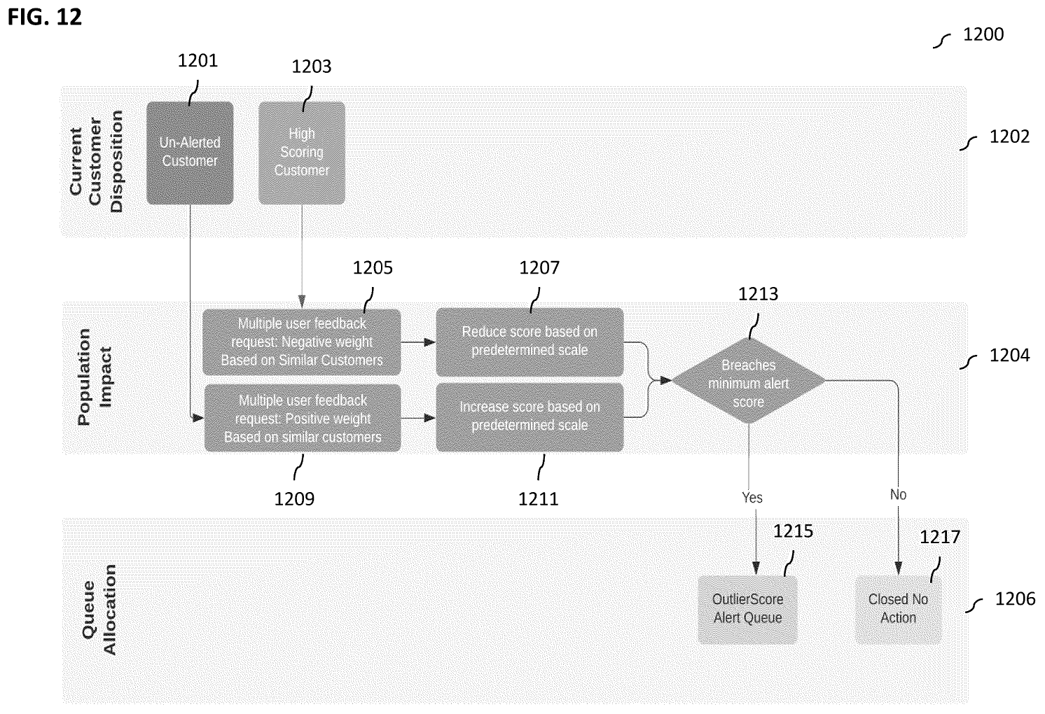

FIG. 12 is a flow diagram illustrating an exemplary process 1200 for using EntityWeights to update the OutlierScore queue allocation, according to some implementations of the current subject matter. The process 1200 may include three phases: a current entity (“customer”) disposition phase 1202, a population impact analysis phase 1204, a queue allocation phase 1206.

During the phase 1202, an un-alerted customer, at 1201, may receive a positive weight based on similar customers being requested, at 1209 during phase 1204, which in turn, may increase their OutlierScore, at 1211. If the new WeightedOutlierScore is greater than a minimum alert threshold, at 1213, the customer may be moved to the OutlierScore Alert Queue, at 1215, during phase 1206.

Conversely, a high scoring customer, at 1203, that gets negative weights based on similar customers being denoted TriggerRequestLess by investigators, at 1205 during phase 1204, may see their OutlierScore reduced, at 1207. Thus, if the new WeightedOutlierScore is below the threshold, at 1213, this customer may be moved to a Closed No Action queue, at 1217, during phase 1206.

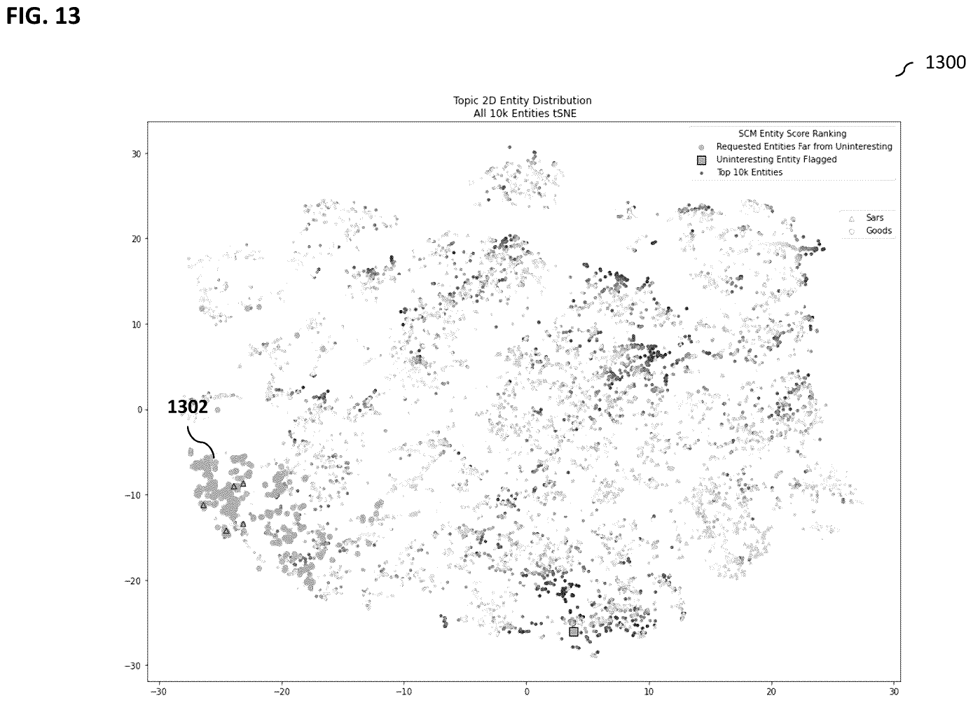

In some implementations, for immediate individual investigator requests, the system 100 may be used by an individual investigator during a review of a specific entity to immediately view other entities that are close in distance using the pairwise distance metric discussed above. The investigator may then review those entities and select to escalate accordingly, in a similar fashion to a review of entity networks. Here, the review may be focused on the type of interesting activity found for that initial customer, rather than a full entity review. In cases, where the entity requested has already triggered an existing alert, the investigator may close it with interest. FIG. 13 illustrates an exemplary experimental density behavior plot 1300 for a plurality of entities that may be displayed on a user interface of a user device (e.g., investigator UI 103 of the device 102c). The plot 1300 may be generated when an investigator has selected an entity as uninteresting and has requested to view more diverse entities (at 1302). The investigator may also view other interesting activity that has been flagged around those that were requested. This may help narrow down the type of activity to look for.

In some implementations, the system 100 may include a module to track and/or supervise performance of the investigator(s). The supervisor role of the system is presented with which investigators may be requesting interesting cases and weigh those requests accordingly and/or use it for training purposes the help improve the overall process. As the system 100 tracks performance of all requests for more, and/or less similar cases, it may then look at the likelihood that other investigators will find interesting cases in those requests and compare them against the likelihood that the initial analyst finds the activity interesting. Differences of more than a particular statistical metric may then be flagged and sent to a specific team that may compare the decisions made by an analyst against current guidelines to help with coaching or update existing guidelines if the activity warrants it. This approach differs from a traditional performance evaluation that currently exists in most institutions, where an investigator is evaluated based on the actual customers being investigated. The novel assessment being presented here looks at how the requested entities, that are near the investigated entity, are dispositioned by other investigators. Each investigator may be assigned an InvestigatorConsistencyScore based on the outcome of the recommended entities. If the score falls below a certain threshold, the investigator may be flagged for review.

The system 100 may also determine InvestigatorInterestingPercentage as a ratio of interesting entities found, over the total entities recommended, weighted by the number of times the entity has been recommended by other investigators as well, as follows:

$$( 10 )$$

$${InvestigatorInterestingPercentage}_{i} = {\sum }_{k} \frac{\frac{{Customer}_{k}}{{Weight}_{k} * {d}_{t , k}} * InterestingFlag}{\frac{{Customer}_{k}}{{Weight}_{k} * {d}_{t , k}}}$$

where, Customerₖ=Un-Alerted customer, recommended for investigation, that is close in distance to original customer under review; Weightₖ=Number of times the customer has also been requested by other investigators when reviewing other customers; InterestingFlag =Flag disposition for when a customer has interesting activity; and d_{t,k}=Number of days t since investigator k requested more of the customer.

This score may decay over time so as to not bias the score towards older dispositions. That percentage may then be normalized and bounded to generate a final InvestigatorConsistencyScore as follows:

$${InvestigatorConsistencyScore}_{i} = \frac{MaxScore}{1 + {e}^{- ( α + β * Imvestigator Interesting {Percentage}_{i} )}} \qquad ( 11 )$$

where, MaxScore is the upper bound for the highest possible score achievable by any investigator; α and β are predefined shift and scale parameters to adjust the distribution of scores to fit requirements.

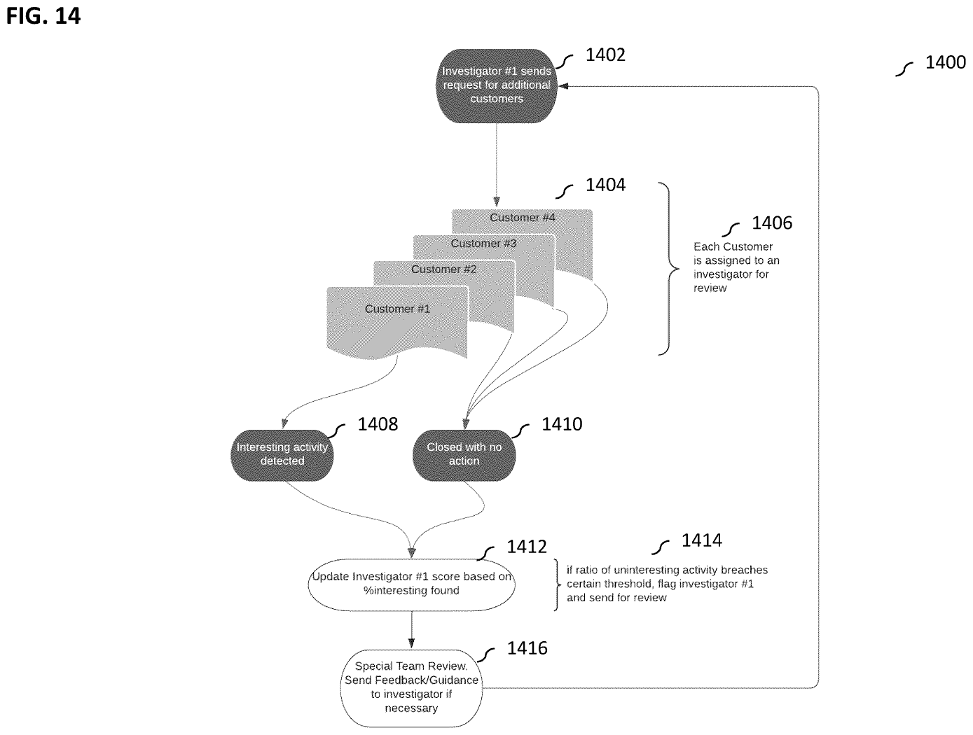

FIG. 14 is a flow chart illustrating an exemplary process 1400 for determining investigator consistency score, according to some implementations of the current subject matter. An investigator, at 1402, may request more entities “customers” 1-4 1404. Each of these customers 1404 may be sent for review by a random investigator, at 1406. Customers that are ultimately dispositioned as interesting, at 1408, may have a positive impact on the InvestigatorConsistencyScore, while those found as non-interesting, at 1410, may impact the score negatively. The score is updated at 1412 in accordance with resolutions at 1408-1410. Investigators that constantly trigger non-interesting customers can be sent for further review and training, at 1414. The investigator may also be provided with feedback, at 1416.

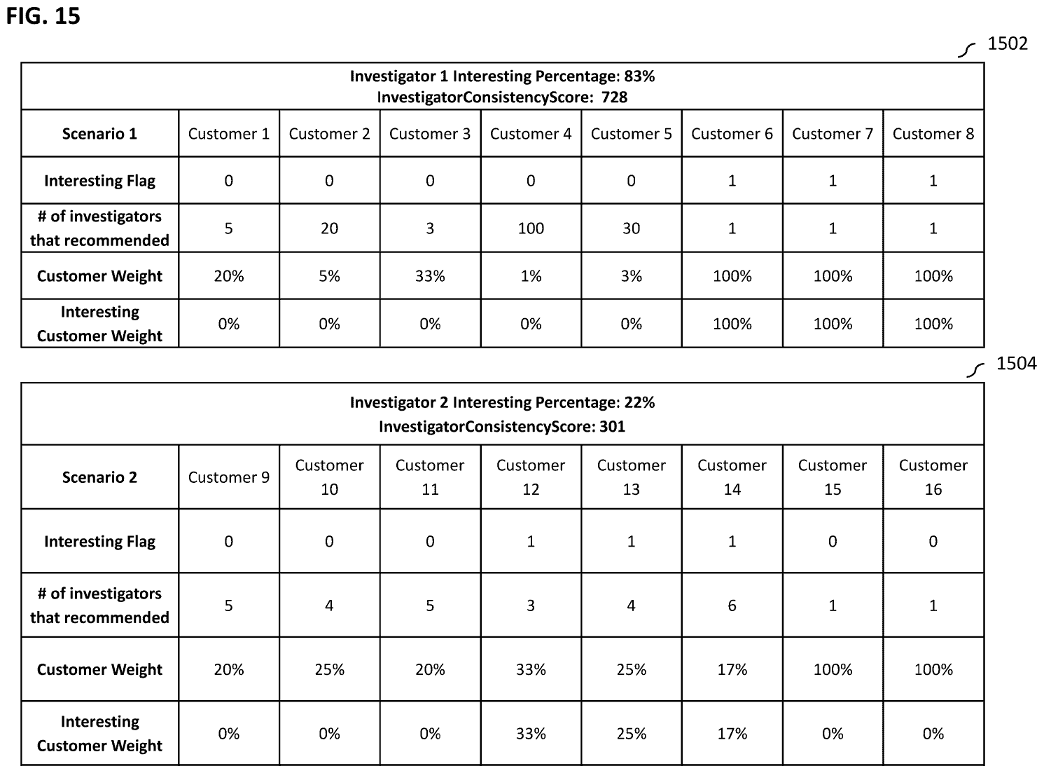

FIG. 15 illustrates exemplary, experimental tables 1502, 1504 showing investigators performance. In particular, the tables 1502, 1504 illustrate how the InvestigatorConsistencyScore may be determined for two investigators (table 1502 for investigator 1, and table 1504 for investigator 2) that requested customers near their current customers. Scores may be normalized using the formula above, with an α and β of −1.5 and 3 respectively and bounded at 999, as an example.

As shown in FIG. 15, results for investigator 1 (in table 1502) show that 5 of the 8 customers were ultimately determined to be not interesting after being worked as part of a normal alert process. Since those customers were also in close proximity to a customer that other investigators requested, it does not highly penalize the investigator. Customer 2 for example, was part of 20 other requests from other investigators, meaning they were in proximity to 20 other interesting customers. The 3 interesting customers, however, are highly weighted and thus increase the score, since they were not part of any other requests. Investigator 1 scores high (738) because that investigator is recommending customers that are ultimately interesting and not highlighted by other investigators.

Results for investigator 2 (in table 1504) also show 5 of the 8 customers were not interesting. However, the score here is considerably lower since those non-interesting were on average weighted higher. 2 of the 8 non interesting were not recommended by any other investigator, while the 3 interesting were recommended elsewhere and thus were weighted less heavily. Investigator 2 scores low (301) because they are highlighting customers that others are not, and that are not interesting. Given the low score, investigator 2 should be reviewed to determine why they are highlighting those customers, and provided with the appropriate training.

Thus, in some implementations, the current subject matter may be configured to provide one or more of the following advantages and/or features. It may serve as an effective training time method to score entities for outliers and rare events, including an ability to enhance the diversity of outliers found by unsupervised machine learning. It may also function as a run-time system where these scores may be presented to multiple investigative users, and their feedback is included in the system such that more novel and interesting types of rare entity behavior is found over time. Once sufficient numbers of examples of a new behavior are found, they can be including in the training set of a supervised machine learning model, to enhance the efficiency of detecting these new behaviors. Additionally, the current subject matter may provide a way for evaluating consistency of each investigator's contributions to the feedback process, so that the process of discovering new entity behavior can be well-governed.

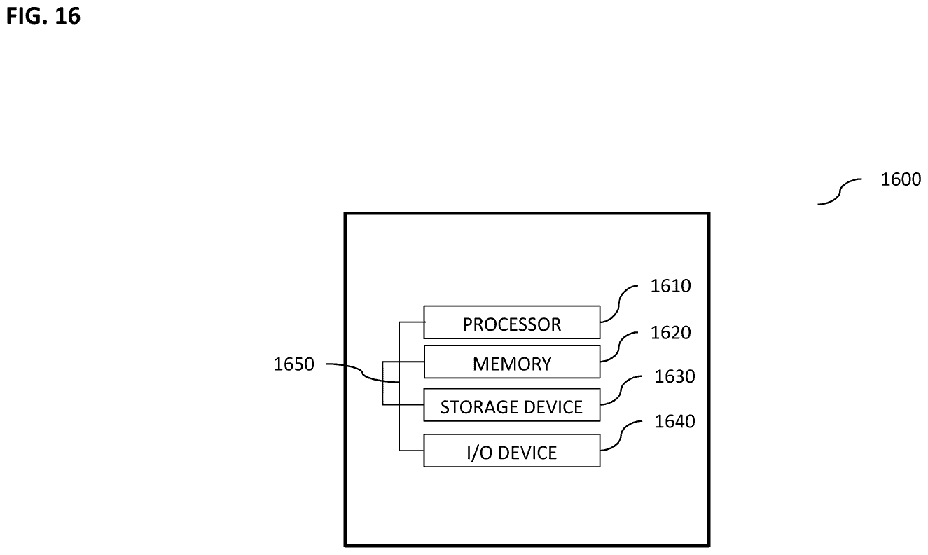

In some implementations, the current subject matter may be configured to be implemented in a system 1600, as shown in FIG. 16. The system 1600 may include a processor 1610, a memory 1620, a storage device 1630, and an input/output device 1640. Each of the components 1610, 1620, 1630 and 1640 may be interconnected using a system bus 1650. The processor 1610 may be configured to process instructions for execution within the system 1600. In some implementations, the processor 1610 may be a single-threaded processor. In alternate implementations, the processor 1610 may be a multi-threaded processor. The processor 1610 may be further configured to process instructions stored in the memory 1620 or on the storage device 1630, including receiving or sending information through the input/output device 1640. The memory 1620 may store information within the system 1600. In some implementations, the memory 1620 may be a computer-readable medium. In alternate implementations, the memory 1620 may be a volatile memory unit. In yet some implementations, the memory 1620 may be a non-volatile memory unit. The storage device 1630 may be capable of providing mass storage for the system 1600. In some implementations, the storage device 1630 may be a computer-readable medium. In alternate implementations, the storage device 1630 may be a floppy disk device, a hard disk device, an optical disk device, a tape device, non-volatile solid state memory, or any other type of storage device. The input/output device 1640 may be configured to provide input/output operations for the system 1600. In some implementations, the input/output device 1640 may include a keyboard and/or pointing device. In alternate implementations, the input/output device 1640 may include a display unit for displaying graphical user interfaces.

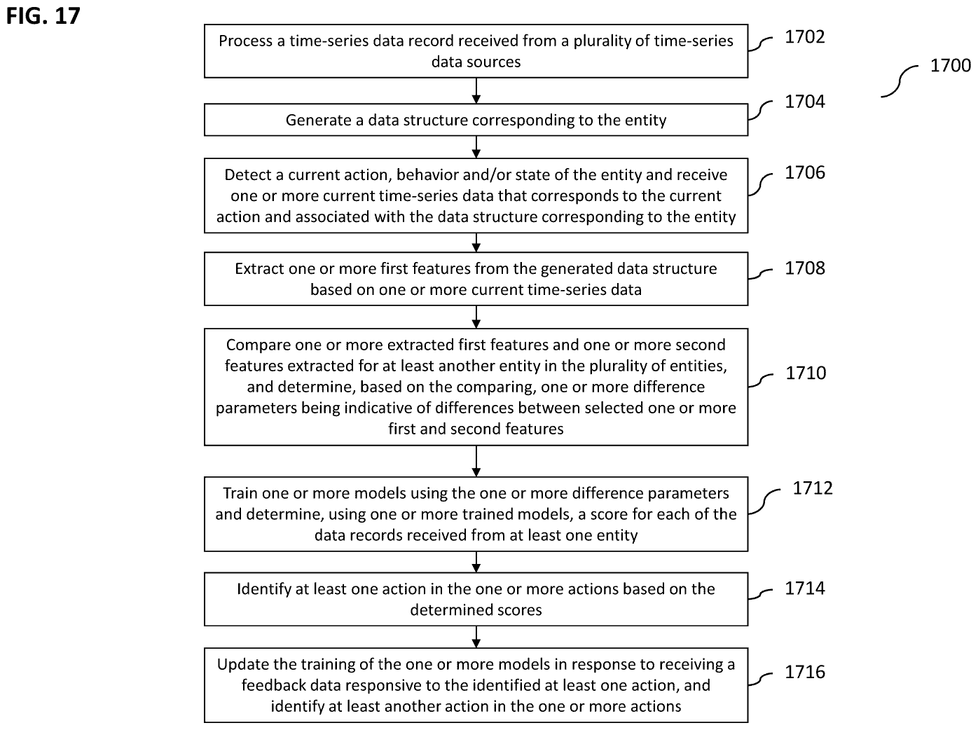

FIG. 17 illustrates an example of a method 1700 for detecting a diverse set of rare behavior, according to some implementations of the current subject matter. The method 1700 may be performed by the system 100, including various features shown in FIGS. 2-15. For example, the process 1700 may be executed using the engine 104 and/or any of the devices 102 (shown in FIG. 1), wherein the engine(s) may be any combination of hardware and/or software.

At 1702, the engine 104 may process a time-series data record received from a plurality of time-series data sources. The time-series data record may represent one or more actions executed by an entity in a plurality of entities and stored by at least one time-series data store in the plurality of time-series data stores.

At 1704, the engine 104 may generate a data structure (e.g., an entity profile) corresponding to the entity. The generated data structure may identify the entity and include one or more representations of processed time-series data (e.g., historical behavior) identifying one or more types of observed behavior or actions executed by the entity. These behaviors and actions may include, for example, opening an account, transferring funds, the temperature of a motor, etc.

At 1706, the engine 104 may detect a current action, behavior and/or state of the entity and receive one or more current time-series data that corresponds to the current action and associated with the data structure corresponding to the entity. The engine 104 may be configured to detect outliers in the current event, behavior and/or state.

At 1708, one or more first features may be extracted by the engine 104 from the generated data structure based on one or more current time-series data. In particular, the engine 104 may perform feature extraction from the entity profile and current input data.

At 1710, the engine 104 may compare one or more extracted first features and one or more second features extracted for at least another entity in the plurality of entities. The engine 104 may then determine, based on the comparison, one or more difference parameters being indicative of differences between the selected one or more first and second features. In particular, the engine 104 may determine distances and/or diversity of entities, as discussed above.

At 1712, the engine 104 may perform training of one or more models, using the difference parameters, where selection of over- or under-representation of training exemplars may be performed. These may refer to a representation weight of the training exemplar in the model training (each record may be assumed equal weight but this parameter allows for it to be more or less important in its contribution to the final training). Then, the engine may determine, using the trained models, a score for each of the data records received from the entity. Thus, one or more outlier actions, behaviors and/or states may be determined.

At 1714, at least one action (in the one or more actions executed by the entity) may be identified by the engine 104 based on the determined scores. Such actions may be determined to be questionable (e.g., fraudulent, etc.).

At 1716, the engine 104 may update the training of one or more models in response to receiving a feedback data responsive to the identified at least one action, and identify at least another action.

In some implementations, the current subject matter can include one or more of the following optional features. At least one of the first features and the second features may include one or more latent features. The training of the models may be performed using the selected first and second features.

In some implementations, the training may include selecting at least one over- and under-representation of a training exemplar or no change to representation.

In some implementations, the feedback data may include feedback data responsive to a utility of the identified at least one action.

In some implementations, the processing may include monitoring the actions executed by the entity, and receiving the time-series data from the plurality of time-series data sources. The actions, behaviors and/or state of the entity may be summarized by one or more representations and may include at least one previously executed action (e.g., historical actions by the entity).

In some implementations, the time-series data may be received during at least one of the following time periods: one or more periodic time intervals, one or more irregular time intervals, and any combination thereof. The time-series data may represents one or more actions executed by the entity during a predetermined period of time.

In some implementations, at least one entity and at least another entity may include at least one of the following: related entities, unrelated entities, and any combination thereof.

In some implementations, one or more difference parameters of the representations may include at least one of the following: latent parameters determined for least comparable entities, parameters determined for most comparable entities, and any combination thereof. This may include a diversity metric for least/most likely entities.

In some implementations, at least another identified action may include at least one of the following: an action identified in addition to the at least one identified action, an action identified for replacing at least one identified action, no action, and any combination thereof (e.g., feedback requests for actions “TriggerRequestMore”, “TriggerRequestLess”, etc.).

In some implementations, the updating may include assigning one or more weight parameters to at least one of: at least one entity and one or more actions executed by the entity, and generating an updated model and an updated score for each of the actions executed by the entity based on the weight parameters. The weight parameters may be determined based on at least the received feedback data. In some implementations, the received feedback data may include one or more labels associated with at least one of: at least one entity and one or more actions executed by the at least one entity. The weight parameters may be determined based on a number of times the feedback data is received for at least one of: the entity and at least another entity being similar to the entity and determined to be within a predetermined distance of the entity. The received feedback data may include feedback data associated with at least another entity being similar to the entity. The received feedback data may include an aggregate feedback data associated with at least one entity and at least another entity being similar to the entity. The feedback data may include a feedback data associated with one or more actions executed by at least one of: at least one entity and at least another entity being similar to the entity. One or more actions may include at least one of the following: at least one identified action, an action identified for replacing the identified action, no action, and any combination thereof.

In some implementations, the method may include generating a consistency score one or more of the investigative users of the system, the consistency score being determined based on receiving a number of times a similar feedback data for at least one of: at least one entity, at least another entity being similar to the entity and determined to be within a predetermined distance of the entity, and one or more actions executed by at least one of: at least one entity and at least another entity being similar to the entity, and any combination thereof, and determining, based on the generated consistency score, whether to use the received feedback data in the updating.

In some implementations, the method may include repeating at least one of the processing, the generating, the detecting, the extracting, the comparing, the training, the identifying, and the updating based on the received feedback data.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer implemented method, comprising:
processing, using at least one processor, a time-series data received from a plurality of time-series data sources, the time-series data representing one or more actions executed by an entity in a plurality of entities and stored by at least one time-series data source in the plurality of time-series data sources;
generating, using the at least one processor, a data structure corresponding to the entity, the generated data structure identifying the entity and including one or more representations of processed time-series data identifying one or more actions executed by the entity;
detecting, using the at least one processor, a current action executed by the entity and receiving one or more current time-series data corresponding to the current action and associated with data structure corresponding to the entity;
extracting, using the at least one processor, one or more first features from the generated data structure based on one or more current time-series data;
comparing, using the at least one processor, one or more extracted first features and one or more second features extracted for at least another entity in the plurality of entities, and determining, based on the comparing, one or more difference parameters being indicative of differences between selected one or more first and second features;
training, using the at least one processor, one or more models, using the one or more difference parameters, and determining, using the one or more trained models, a score for each of the one or more actions executed by the at least one entity;
identifying, using the at least one processor, at least one action in the one or more actions based on the determined scores; and
updating, using the at least one processor, the training of the one or more models in response to receiving a feedback data responsive to the identified at least one action, and identifying at least another action in the one or more actions.

2. The method according to claim 1, wherein at least one of the one or more first features and the one or more second features include one or more latent features.

3. The method according to claim 1, wherein the training of the one or more models is performed using the selected one or more first and second features.

4. The method according to claim 1, wherein the training includes selecting at least one over- and under-representation of a training exemplar or no change to representation.

5. The method according to claim 1, wherein the feedback data includes feedback data responsive to a utility of the identified at least one action. and

6. The method according to claim 1, wherein the processing includes
monitoring, using the at least one processor, the one or more actions executed by the entity; and
receiving, using the at least one processor, the time-series data from the plurality of time-series data sources.

7. The method according to claim 1, wherein the one or more actions executed by the entity are summarized by the one or more representations and include at least one previously executed action.

8. The method according to claim 1, wherein the time-series data is received during at least one of the following time periods: one or more periodic time intervals, one or more irregular time intervals, and any combination thereof.

9. The method according to claim 1, wherein the time-series data represents one or more actions executed by the entity during a predetermined period of time.

10. The method according to claim 1, wherein the at least one entity and the at least another entity include at least one of the following: related entities, unrelated entities, and any combination thereof.

11. The method according to claim 1, wherein the one or more difference parameters of the one or more representations include at least one of the following: latent parameters determined for least comparable entities, parameters determined for most comparable entities, and any combination thereof.

12. The method according to claim 1, wherein the at least another identified action includes at least one of the following: an action identified in addition to the at least one identified action, an action identified for replacing the at least one identified action, no action, and any combination thereof.

13. The method according to claim 12, wherein the updating including
assigning, using the at least one processor, one or more weight parameters to at least one of the at least one entity and the one or more actions executed by the at least one entity; and
generating, using the at least one processor, an updated model and an updated score for each of the one or more actions executed by the at least one entity based on the one or more weight parameters;
wherein the one or more weight parameters are determined based on at least the received feedback data.

14. The method according to claim 13, wherein the received feedback data include one or more labels associated with at least one of the at least one entity and the one or more actions executed by the at least one entity.

15. The method according to claim 14, wherein the one or more weight parameters being determined based on a number of times the feedback data is received for at least one of: the at least one entity and at least another entity being similar to the at least one entity and determined to be within a predetermined distance of the at least one entity.

16. The method according to claim 15, wherein the received feedback data includes feedback data associated with the at least another entity being similar to the at least one entity.

17. The method according to claim 15, wherein the received feedback data includes an aggregate feedback data associated with the at least one entity and the at least another entity being similar to the at least one entity.

18. The method according to claim 15, wherein the feedback data includes a feedback data associated with the one or more actions executed by at least one of: the at least one entity and the at least another entity being similar to the at least one entity.

19. The method according to claim 18, wherein the one or more actions include at least one of the following: the at least one identified action, an action identified for replacing the at least one identified action, no action, and any combination thereof.

20. The method according to claim 15, further comprising
generating a consistency score for the received feedback data, the consistency score being determined based on receiving a number of times a similar feedback data is received for at least one of: the at least one entity, the at least another entity being similar to the at least one entity and determined to be within a predetermined distance of the at least one entity, and the one or more actions executed by at least one of: the at least one entity and the at least another entity being similar to the at least one entity, and any combination thereof; and
determining, based on the generated consistency score, whether to use the received feedback data in the updating.

21. The method according to claim 1, further comprising repeating at least one of the processing, the generating, the detecting, the extracting, the comparing, the training, the identifying, and the updating based on the received feedback data.

22. A system comprising:
at least one programmable processor; and
a non-transitory machine-readable medium storing instructions that, when executed by the at least one programmable processor, cause the at least one programmable processor to perform operations comprising:
processing, using at least one processor, a time-series data received from a plurality of time-series data sources, the time-series data representing one or more actions executed by an entity in a plurality of entities and stored by at least one time-series data source in the plurality of time-series data sources;
generating, using the at least one processor, a data structure corresponding to the entity, the generated data structure identifying the entity and including one or more representations of processed time-series data identifying one or more actions executed by the entity;
detecting, using the at least one processor, a current action executed by the entity and receiving one or more current time-series data corresponding to the current action and associated with data structure corresponding to the entity;
extracting, using the at least one processor, one or more first features from the generated data structure based on one or more current time-series data;
comparing, using the at least one processor, one or more extracted first features and one or more second features extracted for at least another entity in the plurality of entities, and determining, based on the comparing, one or more difference parameters being indicative of differences between selected one or more first and second features;
training, using the at least one processor, one or more models, using the one or more difference parameters, and determining, using the one or more trained models, a score for each of the one or more actions executed by the at least one entity;
identifying, using the at least one processor, at least one action in the one or more actions based on the determined scores; and
updating, using the at least one processor, the training of the one or more models in response to receiving a feedback data responsive to the identified at least one action, and identifying at least another action in the one or more actions.

23. A computer program product comprising a non-transitory machine-readable medium storing instructions that, when executed by at least one programmable processor, cause the at least one programmable processor to perform operations comprising:
processing, using at least one processor, a time-series data received from a plurality of time-series data sources, the time-series data representing one or more actions executed by an entity in a plurality of entities and stored by at least one time-series data source in the plurality of time-series data sources;
generating, using the at least one processor, a data structure corresponding to the entity, the generated data structure identifying the entity and including one or more representations of processed time-series data identifying one or more actions executed by the entity;
detecting, using the at least one processor, a current action executed by the entity and receiving one or more current time-series data corresponding to the current action and associated with data structure corresponding to the entity;
extracting, using the at least one processor, one or more first features from the generated data structure based on one or more current time-series data;
comparing, using the at least one processor, one or more extracted first features and one or more second features extracted for at least another entity in the plurality of entities, and determining, based on the comparing, one or more difference parameters being indicative of differences between selected one or more first and second features;
training, using the at least one processor, one or more models, using the one or more difference parameters, and determining, using the one or more trained models, a score for each of the one or more actions executed by the at least one entity;
identifying, using the at least one processor, at least one action in the one or more actions based on the determined scores; and
updating, using the at least one processor, the training of the one or more models in response to receiving a feedback data responsive to the identified at least one action, and identifying at least another action in the one or more actions.
